(19) United States
(12) Patent Application Publication
(10) Pub. No.: US 2013/0291589 A1
(43) Pub. Date: Nov. 7, 2013

(54) Silicon Carbide Princess Cut Gemstone

(71) Applicant: Anthony Ritchie, Kent, WA (US)

(72) Inventor: Anthony Ritchie, Kent, WA (US)

(21) Appl. No.: 13/462,918

(22) Filed: May 3, 2012

(51) Int. Cl. A44C 17/00; B28D 5/00

(52) U.S. Cl. 63/32; 125/30.01

(57) ABSTRACT

The instant application discloses, among other things, a specific set of cutting proportions tailored for the optical characteristics of Silicon Carbide (“SiC”) Princess cut gemstone.

### FIELD

This disclosure relates to a way to produce a Silicon Carbide Princess Cut gemstone.

### BACKGROUND

Generally, facets on precious and semi-precious gemstones are cut so as to provide brilliance to these gemstones in an economical manner. Gemstones may also be cut to provide reflections with patterns visible.

### SUMMARY OF THE INVENTION

The instant application discloses, among other things, a specific set of cutting proportions tailored for the optical characteristics of Silicon Carbide (“SiC”) Princess cut gemstone.

Silicon Carbide (SiC) is a compound of silicon and carbon. It exists in a number of crystalline forms, often grouped as polytypes of similar structures. Three common polytypes are 3C (β), 4H, and 6H (α). 3C (β) has a cubic crystal structure; 4H and 6H (α) each have hexagonal crystal structures.

### BRIEF DESCRIPTION OF THE DRAWINGS

FIG. 1 is a side view of an example of an SiC Princess Cut gemstone.

FIG. 2 is a top view of an example of an SiC Princess Cut gemstone.

FIG. 3 is a bottom view of an example of SiC Princess Cut gemstone.

FIG. 4 is an illustration of a flowchart of one way to create an SiC Princess Cut gemstone.

### DESCRIPTION OF THE INVENTION

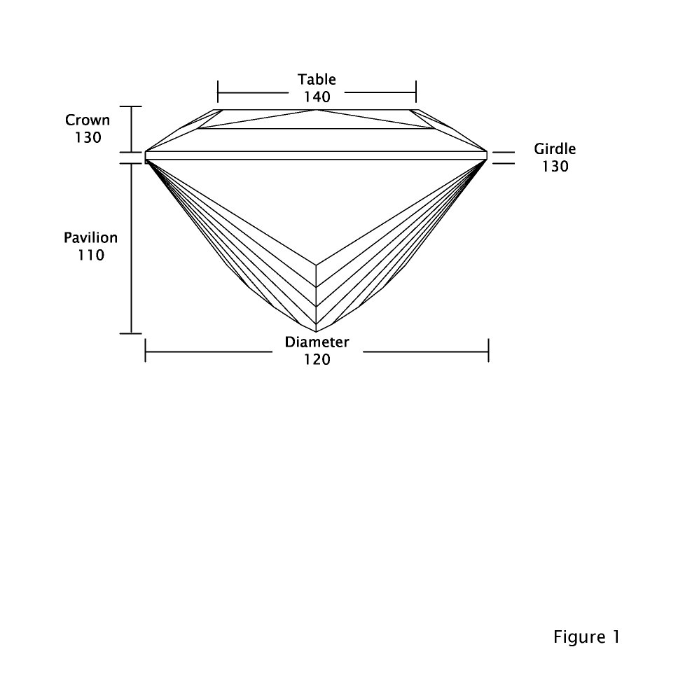

FIG. 1 is a side view of an example of an SiC Princess cut gemstone. Crown 130 is the portion of a gem above the girdle. Crown 130 has Facets 210, 225, 230, 235. Girdle 130 is the outer edge of the gemstone, separating the Crown 100 and the Pavilion 110. Girdle 130 is generally located near the area of a gemstone at the widest portion of the gemstone, where Diameter 120 indicates the edge-to-edge width of the gemstone. Table 140 is the largest facet on the gemstone.

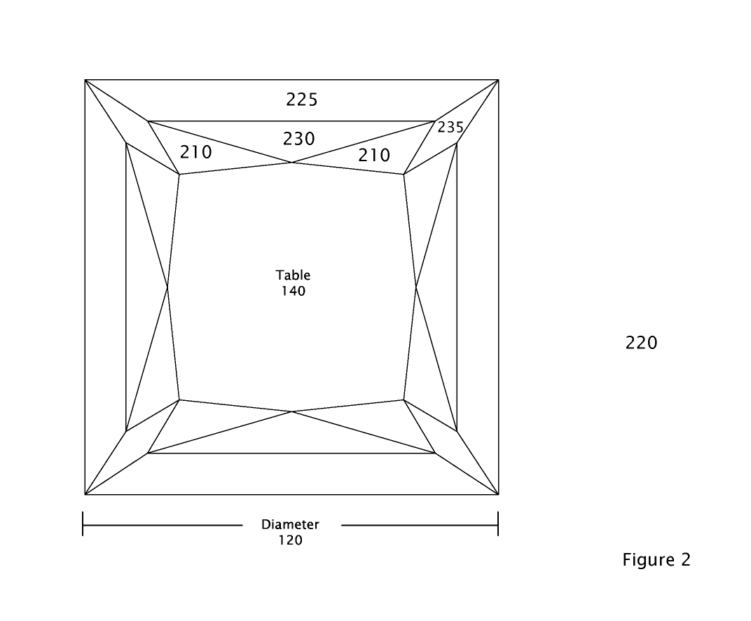

FIG. 2 is a top view (Crown side) of an example of an SiC Princess Cut gemstone. The SiC gemstone has a four-fold symmetry. The angles for this cut may be:

| Facet | Degrees |
|---|---|
| Crown Star Facets 210 | 24.5 |
| Crown Girdle Facets 225 | 37.3 |
| Crown Bezel Facets 230 | 31.7 |
| Crown Corner Bezel Facets 235 | 23.1 |

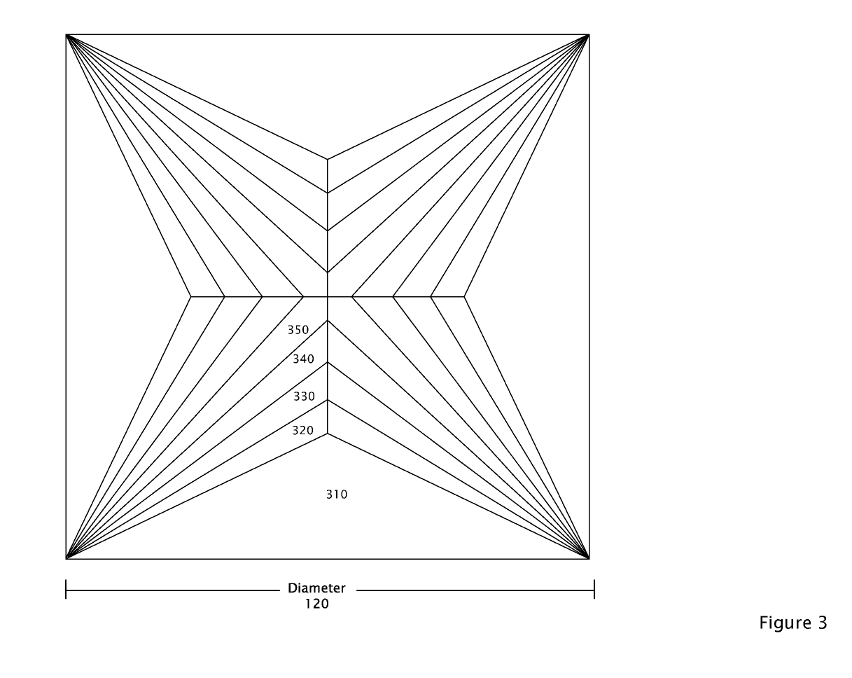

FIG. 3 is a bottom view (Pavilion side) of an example of an SiC Princess cut gemstone. The cuts may be made with multiple chevron shapes in several tiers.

The angles for this cut may be:

| Facet | Degrees |
|---|---|
| Pavilion Girdle Facets 310 | 55.7 |
| Pavilion Tier One Facets 320 | 48.5 |
| Pavilion Tier Two Facets 330 | 43.5 |
| Pavilion Tier Three Facets 340 | 40.0 |
| Pavilion Tier Four Facets 350 | 38.9 |

One having skill in the art will recognize that slight variations, up to 0.2 degrees greater or smaller, in the cutting angle may still produce a desired Princess cut SiC gem.

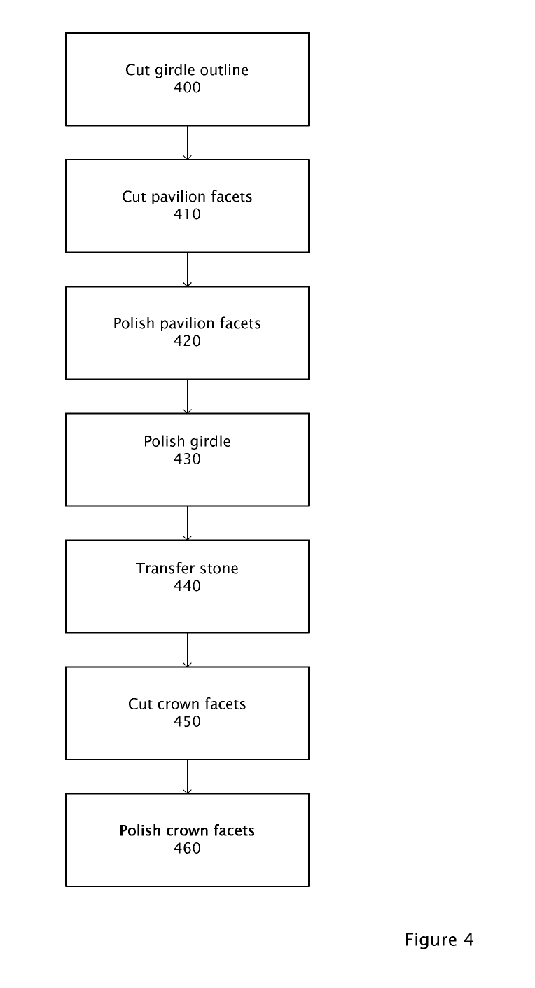

FIG. 4 is an illustration of a flowchart of one way to create a Princess cut gemstone. In this example, a girdle outline is cut 400 to provide a diameter of the SiC gemstone. The pavilion facets are cut 410, including pavilion main facets and pavilion girdle facets.

The pavilion facets are polished 420, as is the girdle 430. The stone is transferred to allow cutting and polishing of the crown side.

The crown bezel, star, crown corner bezel, and girdle facets are cut 450, and polished 460.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit Silicon Carbide Princess Cut Gemstone and scope of the invention, the invention resides in the claims hereinafter appended.

1. An SiC gemstone, comprising:
a crown portion comprising:
a plurality of crown star facets cut at an angle of approximately 24.5 degrees;
a plurality of crown bezel facets cut at an angle of approximately 31.7 degrees;
a plurality of crown girdle facets cut at an angle of approximately 37.3 degrees;
a plurality of crown corner bezel facets cut at an angle of approximately 23.1 degrees;
a pavilion portion comprising:
a plurality of pavilion girdle facets cut at an angle of approximately 55.7 degrees;
a plurality of pavilion tier one facets cut at an angle of approximately 48.5 degrees;
a plurality of pavilion tier two facets cut at an angle of approximately 43.5 degrees;
a plurality of pavilion tier three facets cut at an angle of approximately 40.0 degrees;
a plurality of pavilion tier four facets cut at an angle of approximately 38.9 degrees;
a girdle portion abutting the crown portion and extending along a predetermined plane.

2. The SiC gemstone of claim 1 wherein there are eight crown star facets cut at an angle of approximately 24.5 degrees.

3. The SiC gemstone of claim 1 wherein there are four crown girdle facets cut at an angle of approximately 37.3 degrees;

4. The SiC gemstone of claim 1 wherein there are four of crown bezel facets cut at an angle of approximately 31.7 degrees.

5. The SiC gemstone of claim 1 wherein there are four crown corner bezel facets cut at an angle of approximately 23.1 degrees.

6. The SiC gemstone of claim 1 wherein there are four pavilion girdle facets cut at an angle of approximately 55.7 degrees.

7. The SiC gemstone of claim 1 wherein there are eight pavilion tier one facets cut at an angle of approximately 48.5 degrees.

8. The SiC gemstone of claim 1 wherein there are eight pavilion tier two facets cut at an angle of approximately 43.5 degrees.

9. The SiC gemstone of claim 1 wherein there are eight pavilion tier three facets cut at an angle of approximately 40.0 degrees.

10. The SiC gemstone of claim 1 wherein there are eight pavilion tier four facets cut at an angle of approximately 38.9 degrees.

11. The SiC gemstone of claim 1 wherein the SiC is selected from a group comprising 6H, 4H, and 3C SiC.

12. A method of cutting an SiC gemstone, comprising:
cutting a girdle outline of the SiC gemstone;
cutting a girdle facet on a pavilion side of the SiC gemstone at an angle of approximately 55.7 degrees;
cutting a tier one facet on the pavilion side of the SiC gemstone at an angle of approximately 48.5 degrees;
cutting a tier two facet on the pavilion side of the SiC gemstone at an angle of approximately 43.5 degrees;
cutting a tier three facet on the pavilion side of the SiC gemstone at an angle of approximately 40.0 degrees;
cutting a tier four facet on the pavilion side of the SiC gemstone at an angle of approximately 38.9 degrees;
cutting a bezel facet on a crown side of the SiC gemstone at an angle of approximately 31.7 degrees;
cutting a girdle facet on the crown side of the SiC gemstone at an angle of approximately 37.3 degrees;
cutting a star facet on the crown side of the SiC gemstone at an angle of approximately 24.5 degrees; and
cutting a corner bezel facet on the crown side of the SiC gemstone at an angle of approximately 23.1 degrees.

13. The method of claim 12 wherein the cutting is performed by a robotic cutting machine.

14. The method of claim 12 further comprising polishing the facets on the crown side of the SiC gemstone.

15. The method of claim 12 further comprising polishing the facets on the pavilion side of the SiC gemstone.
